(19) United States
(12) Patent Application Publication
(10) Pub. No.: US 2024/0280389 A1
(43) Pub. Date: Aug. 22, 2024

(54) Method for Determining a Flow Rate of a Medium with a Magnetic-Inductive Flowmeter, Method for Operating a Filling System with a Magnetic-Inductive Flowmeter, Magnetic-Inductive Flowmeter and Filling System with a Magnetic-Inductive Flowmeter

(71) Applicant: KROHNE AG, Basel (CH)

(72) Inventor: Arthur den Haan, Leiden (CH)

(21) Appl. No.: 18/336,144

(22) Filed: Jun. 16, 2023

(30) Foreign Application Priority Data
Jun. 20, 2022 (DE) 10 2022 115 308.8

(51) Int. Cl. G01F 1/58; B67D 7/02; B67D 7/36

(52) U.S. Cl. CPC G01F 1/584; B67D 7/02; B67D 7/36

(57) ABSTRACT

A method for determining a flow of a medium with a magnetic-inductive flowmeter includes: flowing a medium through a measuring tube; generating a magnetic field alternating between a first magnetic field strength in first sub-intervals and a second magnetic field strength in second sub-intervals so a measuring voltage present between two measuring electrodes is induced in the medium; carrying out a first measurement in the first sub-intervals and a second measurement in the second sub-intervals; in an interval, carrying out the steps of: determining averaged first and second measurements, determining normalized first and second measurements, determining filtered first measurements by subtracting the normalized first measurement from the first measurement, and determining a filtered second measurement by subtracting the normalized second measurement from the second measurement; and determining a flow rate of the medium using the filtered first and second measurements determined for the interval.

### TECHNICAL FIELD

The invention relates to a method for determining a flow rate of a medium with a magnetic-inductive flowmeter, and a method for operating a filling system with a magnetic-inductive flowmeter. The invention also relates to a magnetic-inductive flowmeter, and a filling system with a magnetic-inductive flowmeter.

### SUMMARY

For determining the flow, the flowmeter comprises a measuring tube, a magnetic field generator, two measuring electrodes and a controller.

Further, a medium is made to flow through the measuring tube. The medium is suitable for having its flow rate determined with a magnetic-inductive flowmeter. It thus exhibits, in particular, an electrical conductivity. The flow rate is, for example, a volume or mass flow of the medium through the measuring tube per time.

Intervals with first sub-intervals and second sub-intervals are generated by the controller in a method step, and a magnetic field alternating between a first setpoint magnetic field strength in the first sub-intervals and a second setpoint magnetic field strength in the second sub-intervals is generated by the controller with the magnetic field generator, i.e. using the magnetic field generator, so that a measuring voltage present between the two measuring electrodes is induced in the medium flowing in the measuring tube. Usually the controller generates the intervals continuously and the sub-intervals, i.e. the first and second sub-intervals, are directly adjacent to each other. The controller drives the magnetic field generator during operation of the magnetic-inductive flowmeter. The controller and the magnetic field generator are designed accordingly. This means that the controller specifies the setpoint magnetic field strength to the magnetic field generator, i.e. either the first or second setpoint magnetic field strength, and the magnetic field generator then generates the corresponding magnetic field with a magnetic field strength in the medium in the measuring tube.

Further, in a method step, a first measurement with a measuring point number of measuring points of the measuring voltage in the first sub-intervals and a second measurement with the measuring point number of measuring points of the measuring voltage in the second sub-intervals is carried out by the controller in each of a measuring number of the intervals. The number of measurements and the number of measuring points are usually specified to the controller. After this method step has been carried out, a measurement number of first measurements and a measurement number of second measurements are available. Each of the measurements, i.e. each first and each second measurement, has a measurement point number of measurement points. Each of the measuring points is a value of the measuring voltage or represents the measuring voltage.

A flow rate of the medium through the measuring tube is determined by the controller using the first measurement and the second measurement in at least one of the intervals.

The invention further relates to a method for operating a filling system. This comprises a magnetic-inductive flowmeter, a filling device and a controller. The magnetic-inductive flowmeter has a measuring tube, a magnetic field generator and two measuring electrodes. The filling device is designed for filling a medium through the measuring tube into containers.

The controller carries out the method described above for determining the flow rate and controls the filling device using the determined flow rate of the medium through the measuring tube so that a container is filled with a predetermined amount of the medium. Thus, the controller is designed to carry out the method. The predetermined amount is usually given to the controller.

The invention further relates to a magnetic-inductive flowmeter comprising a measuring tube, a magnetic field generator, two measuring electrodes and a controller. The controller is designed to carry out the previously described method for determining the flow rate.

The invention further relates to a filling system comprising a magnetic-inductive flowmeter, a filling device and a controller. The magnetic-inductive flowmeter has a measuring tube, a magnetic field generator and two measuring electrodes. The filling device is designed to fill a medium through the measuring tube into containers. The controller is designed to carry out the previously described method for determining the flow rate. In particular, the filling device is designed to carry out the previously described method for operating a filling device.

In all other respects, the explanations in connection with the method for determining the flow rate apply mutatis mutandis to the method for operating a filling system, to the flowmeter and to the filling system.

In the event of a transition from one of the two sub-intervals, i.e. either one of the first or the second sub-intervals, to the other of the two sub-intervals, i.e. either one of the second or the first sub-intervals, the controller also switches from one of the two setpoint magnetic field strengths, i.e. either the first or the second setpoint magnetic field strength, to the other of the two setpoint magnetic field strengths, i.e. the second or the first setpoint magnetic field strength. The magnetic field generator converts the predetermined setpoint magnetic field strength into a magnetic field strength of the magnetic field in the medium in the measuring tube, so that the flowing medium induces the measuring voltage present at the two measuring electrodes into the flowing medium. Parasitic effects cause the measuring voltage to initially overshoot when the change from one of the two setpoint magnetic field strengths to the other of the two setpoint magnetic field strengths takes place, and then asymptotically subside to a constant measuring voltage over time. This overshoot is included in the measurement points of the first and second measurements and causes a zero point error in the determined flow rate. A parasitic effect is capacitive crosstalk.

The object of the present invention is thus to provide a method for determining the flow rate, a method for operating the filling system, an magnetic-inductive flowmeter and a filling system of the type described above in each of which the problem indicated is at least mitigated.

The object is achieved by a method for determining a flow rate having the disclosed features. The previously described method is modified as described below.

First, the following sub-steps of the method are carried out by the controller for at least one of the intervals:

In a first sub-step of the method, an averaged first measurement having a last averaged measurement point from a plurality of the first measurements and an averaged second measurement having a last measurement point from a plurality of the second measurements are determined. Accordingly, the averaged first measurement has a plurality of averaged measurement points, with a last one of these averaged measurement points being the last averaged measurement point. The second averaged measurement also has a plurality of averaged measurement points, with a last one of the averaged measurement points being the last averaged measurement point.

In a second sub-step of the method, a standardized first measurement is determined by subtracting the last averaged measurement point of the averaged first measurement from the averaged first measurement, and a standardized second measurement is determined by subtracting the last averaged measurement point of the averaged second measurement from the averaged second measurement. Thus, the last averaged measurement point is subtracted from each of the averaged measurement points.

In a third sub-step of the method, a filtered first measurement is determined by subtracting the standardized first measurement from the first measurement and a filtered second measurement is determined by subtracting the standardized second measurement from the second measurement.

In a further method step, the controller then determines the flow rate of the medium through the measuring tube using the filtered first measurement and the filtered second measurement determined at least for the one interval.

The zero point error is at least reduced by the method according to the invention.

In one design of the method, the controller also determines the filtered first measurement and/or the filtered second measurement for the interval preceding the interval and determines the flow rate of the medium additionally using the filtered first and/or second measurement. The additional use of a measurement from the interval preceding the interval further reduces the zero point error. This design of the method may be further implemented in various alternative ways.

In a first further development, the controller also determines the filtered first measurement for the interval preceding the interval. Further, a pseudo flow rate measurement value is determined by determining a mean value from each of the filtered first measurement preceding the filtered first measurement, the filtered first measurement, and the filtered second measurement. These mean values are then added, wherein the mean value of the filtered second measurement is weighted by a factor of minus two, and the sum divided by four. The mean values are for example arithmetic mean values. Using the pseudo flow rate measurement value, the flow rate of the medium is then determined. In order to get the correct direction of the flow rate, the direction of the magnetic field is taken into account. The direction of the magnetic field corresponds to the direction of a current flowing through a coil generating the magnetic field. Thus, instead of the direction of the magnetic field, the direction of the current can be taken into account.

In an alternative further development, the controller also determines the filtered second measurement for the interval preceding the interval. A pseudo flow rate measurement value is then determined by determining a mean value from each of the filtered second measurements preceding the filtered second measurement, the filtered second measurement, and the filtered first measurement. These mean values are added, wherein the mean value of the filtered first measurement is weighted by a factor of minus two, and the sum divided by four. The mean values are for example arithmetic mean values. Then, using the pseudo flow rate measurement value, the flow rate of the medium is determined. In order to get the correct direction of the flow rate, the direction of the magnetic field is taken into account.

In a further design, an arithmetic or a cumulative moving or exponential moving average is determined in order to determine the averaged first measurement and the averaged second measurement, respectively. This determination is also carried out by the controller.

In a further design, for determining the averaged first measurement and the averaged second measurement, in each case a curve fitting is carried out with a function at averaged measurement points of the first measurement and at averaged measurement points of the second measurement, and preferably the function has an exponential function.

In a further design, the execution of the first measurement in the first sub-intervals and the second measurement in the second sub-intervals is started after a settling time, respectively. The settling time is usually specified to the controller. Waiting around the settling time causes the overshoot to have already partially subsided, wherein the zero point error is already reduced by itself.

In a further design, the first setpoint magnetic field strength in the first sub-intervals and the second setpoint magnetic field strength in the second sub-intervals are each constant over time. Preferably, the first setpoint magnetic field strength and the second setpoint magnetic field strength have the same magnitude but opposite signs. Then the setpoint magnetic field strength has a rectangular course over time.

The object is also achieved by a method for operating a filling system having the disclosed features. Namely, the controller carries out one of the previously described methods for determining the flow rate.

Further, the object is also achieved by a magnetic-inductive flowmeter having the disclosed features. Namely, the controller is designed to carry out one of the previously described methods for determining the flow rate.

Furthermore, the object is also achieved by a filling system with a magnetic-inductive flowmeter having the disclosed features. Namely, the controller is designed to carry out one of the previously described methods.

In all other respects, the explanations in connection with the method for determining the flow rate apply accordingly to the method for operating a filling system, to the flowmeter and to the filling system.

### BRIEF DESCRIPTION OF THE DRAWINGS

In detail, a plurality of possibilities are given for designing and further developing the method for determining the flow rate, the method for operating a filling system, the magnetic-inductive flowmeter and the filling system. For this, reference is made to the following description of a preferred embodiment in connection with the drawings.

FIG. 1 illustrates an embodiment of a filling system.

FIG. 2 illustrates a flow chart of an embodiment of a method for operating the filling system.

FIG. 3A illustrates intervals generated during execution of the method over the time t.

FIG. 3B illustrates a magnetic field generated during execution of the method over the time t.

FIG. 3C illustrates a measuring voltage generated during execution of the method over the time t.

FIG. 4 illustrates an embodiment of a magnetic-inductive flowmeter.

### DETAILED DESCRIPTION

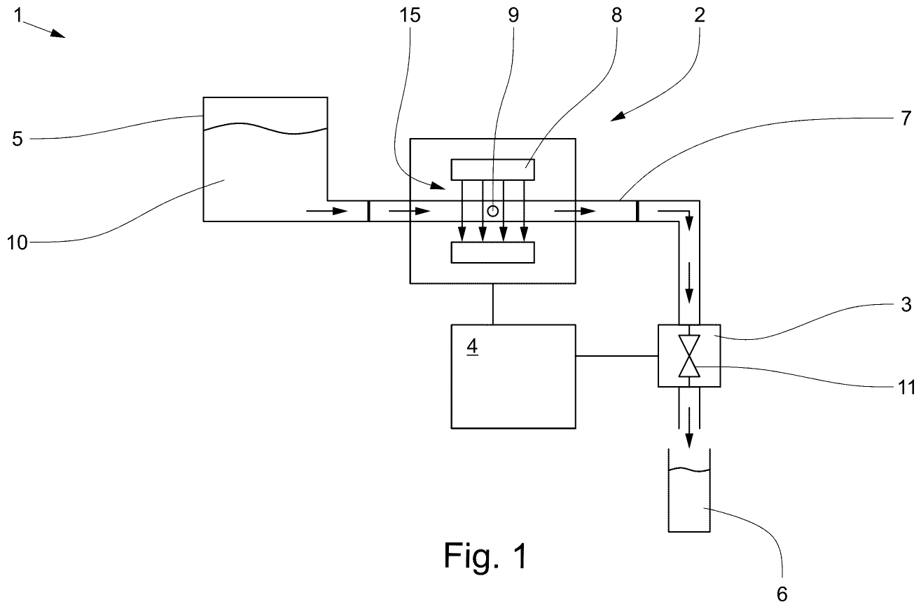

In an abstracted representation, FIG. 1 shows essential features of an embodiment of a filling system 1 during operation. The filling system 1 has a magnetic-inductive flowmeter 2, a filling device 3, a controller 4, a reservoir 5 and a container 6. The flowmeter 2 has a measuring tube 7, a magnetic field generator 8 and two measuring electrodes 9, wherein only one measuring electrode 9 is visible in FIG. 1. The measuring tube 7 is connected to the filling device 3 and the reservoir 5 by further tubes.

The filling device 3 is designed for filling a medium 10 through the measuring tube 7 into the container 6. In this embodiment, the controller 4 is designed not only for controlling the magnetic-inductive flowmeter 2, but also for controlling the filling device 3. In particular, the filling device 3 has a valve 11 which can be controlled by the controller 4. The medium 10 is stored in the reservoir 5. When the controller 4 controls the valve 11 of the filling device 3, the medium 10 flows from the reservoir 5 through the measuring tube 7 and the valve 11 into the container 6, which is filled in this way. The medium 10 is made to flow through the measuring tube 7 in this way. The flow of the medium is indicated by arrows in the measuring tube 7 and the other tubes.

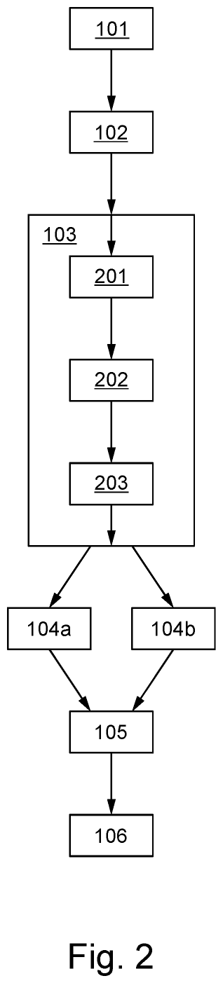

During operation, the filling system 1 carries out an embodiment of a method for operating the filling system 1. FIG. 2 shows a flow chart of this method with essential method steps.

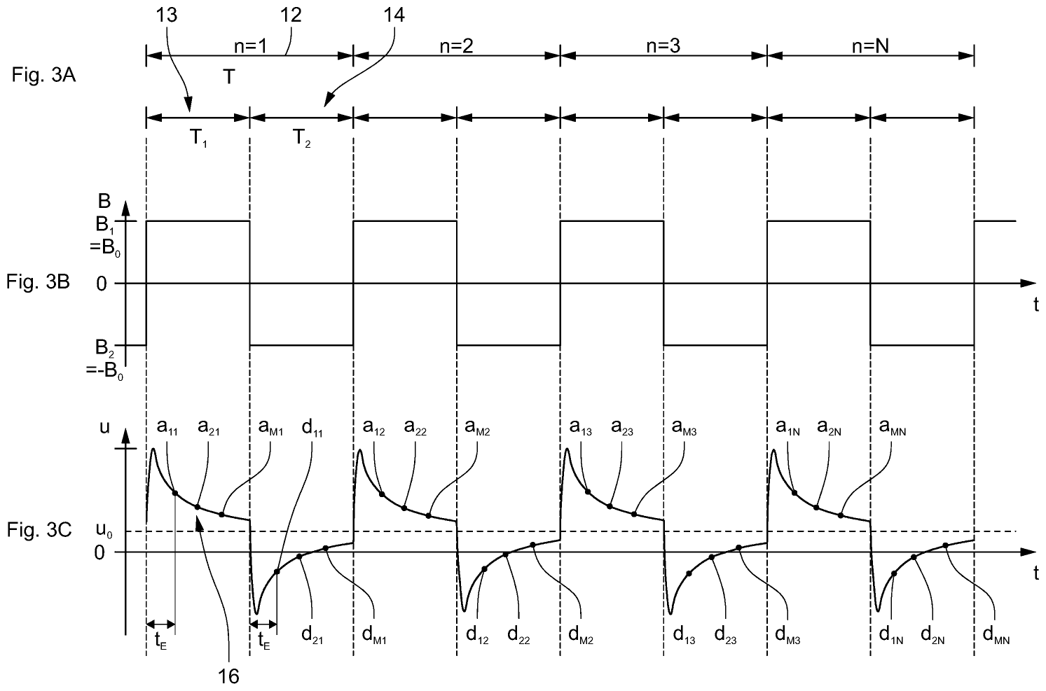

In a first method step 101, the controller 4 generates intervals 12, i.e. n=1, 2, 3, N, with first sub-intervals 13 and second sub-intervals 14, see FIG. 3A. Between n=3 and n=N there is an arbitrary number of further intervals 12, which are not explicitly listed, where N is the measurement number and a positive integer.

Further, the magnetic field generator 8 generates a magnetic field 15 alternating between a first setpoint magnetic field strength B=B₁ in the first sub-intervals 13 and a second setpoint magnetic field strength B=B₂ in the second sub-intervals 14, see FIG. 3B. The first setpoint magnetic field strength B₁ in the first sub-intervals 13 and the second setpoint magnetic field strength B₂ in the second sub-intervals 14 is constant over time t in each case. Thus, the setpoint magnetic field strength B has a rectangular shape over time t.

The first setpoint magnetic field strength B₁, the second setpoint magnetic field strength B₂, a duration T of the intervals 12, a duration T₁ of the first sub-intervals 13 and a duration T₂ of the second sub-intervals 14 are given to the controller 4. The duration of the first sub-intervals T₁ and the duration of the second sub-intervals T₂ are identical here. Also, the absolute values of the first setpoint magnetic field strength B₁ and the second setpoint magnetic field strength B₂ are identical, namely B₀.

In this manner, a measuring voltage u present between the two measuring electrodes 9 is generated when the medium 10 flows through the measuring tube 7, see FIG. 3C. In the present embodiment, the medium flows with a constant velocity greater than zero in the time range shown. Parasitic effects cause the measuring voltage u to initially overshoot and then asymptotically subside with time t to a constant measuring voltage u₀ when the change between the setpoint magnetic field strengths B₁ and B₂ takes place. The overshoot has multiple causes. One cause is induction of the changing magnetic field 15 in wires connecting the electrodes 9 and in the medium 10.

In a second method step 102, in each of the N intervals 12, i.e. n=1, 2, 3, N, in the first sub-intervals 13 a first measurement \vec{a}ₙ is carried out by the controller 4 with a measurement point number M measurement points 16 \vec{a}ₙ=(a₁ₙ,a₂ₙ,a_{Mn})^{T} of the measuring voltage u and in the second sub-intervals 14 a second measurement i, is carried out with the measurement point number M measurement points 16 \vec{d}ₙ=(d₁ₙ,d₂ₙ,d_{Mn})^{T} of the measuring voltage u. The second measurement is carried out by the controller 4 in the first sub-intervals 13. M is a positive integer and can be given to the controller 4.

The first measurement in the first sub-intervals 13 and the second measurement in the second sub-intervals 14 are each started after a settling time t_{E}. In FIG. 3C this is shown only for the first interval 12, i.e. for n=1.

In a third method step 103, the following sub-steps of the method are carried out by the controller 4 for one of the intervals 12, i.e. n:

In a first sub-step of the method 201, on the one hand an averaged first measurement \vec{ā}=(ā₁,ā₂,ā_{M})^{T} with a last averaged measurement point ā_{M} from the N first measurements and, on the other hand, an averaged second measurement \vec{d̅}=(ā₁,ā₂,ā_{M})^{T} with a last averaged measurement point d̅_{M} from the N second measurements are determined.

Namely, in order to determine the averaged first measurement and the averaged second measurement, the controller 4 determines an arithmetic mean value in accordance with

$$\overline{\vec{a}} = \frac{1}{N} {\sum }_{1}^{N} {\vec{a}}_{n} = \frac{1}{N} ( \begin{matrix}{a}_{11} + {a}_{12} + {a}_{13} + {a}_{1 N} \\ {a}_{21} + {a}_{22} + {a}_{23} + {a}_{2 N} \\ {a}_{M 1} + {a}_{M 2} + {a}_{M 3} + {a}_{M N}\end{matrix} ) = ( \begin{matrix}{\overline{a}}_{1} \\ {\overline{a}}_{2} \\ {\overline{a}}_{M}\end{matrix} )$$

$$and$$

$$\overline{\vec{d}} = \frac{1}{N} {\sum }_{1}^{N} {\vec{d}}_{n} = \frac{1}{N} ( \begin{matrix}{d}_{11} + {d}_{12} + {d}_{13} + {d}_{1 N} \\ {d}_{21} + {d}_{22} + {d}_{23} + {d}_{2 N} \\ {d}_{M 1} + {d}_{M 2} + {d}_{M 3} + {d}_{MN}\end{matrix} ) = ( \begin{matrix}{\overline{d}}_{1} \\ {\overline{d}}_{2} \\ {\overline{d}}_{M}\end{matrix} ) .$$

In a second sub-step of the method 202, on the one hand, a standardized first measurement \vec{b}ₙ is determined by subtracting the last averaged measurement point of the averaged first measurement from the averaged first measurement \vec{b}ₙ=\vec{ā}−ā_{M}·\vec{J}_{M} and, on the other hand, a standardized second measurement \vec{e}ₙ is determined by subtracting the last averaged measurement point of the averaged second measurement from the averaged second measurement \vec{e}ₙ=\vec{d̅}−d̅_{M}·\vec{J}_{M}. In the formulas, i, is a unit vector. Thus, for example, the standardized first measurement is

$${\vec{b}}_{n} = ( \begin{matrix}{\overline{a}}_{1} \\ {\overline{a}}_{2} \\ {\overline{a}}_{M}\end{matrix} ) - ( \begin{matrix}{\overline{a}}_{M} \\ {\overline{a}}_{M} \\ {\overline{a}}_{M}\end{matrix} ) = ( \begin{matrix}\overline{{a}_{1}} - {\overline{a}}_{M} \\ {\overline{a}}_{2} - {\overline{a}}_{M} \\ 0\end{matrix} ) .$$

In a third sub-step of the method 203, a filtered first measurement \vec{c}ₙ is determined on the one hand by subtracting the standardized first measurement from the first measurement \vec{c}ₙ=\vec{a}ₙ−\vec{b}ₙ and on the other hand a filtered second measurement \vec{f}ₙ is determined by subtracting the standardized second measurement from the second measurement \vec{f}ₙ=\vec{d}ₙ−\vec{e}ₙ. Thus, for example, the filtered first measurement is

$${\vec{c}}_{n} = ( \begin{matrix}{a}_{1 n} \\ {a}_{2 n} \\ {a}_{3 n}\end{matrix} ) - ( \begin{matrix}{\overline{a}}_{1} - {\overline{a}}_{M} \\ {\overline{a}}_{2} - {\overline{a}}_{M} \\ 0\end{matrix} ) .$$

In a first alternative of a fourth method step 104a, the controller 4 determines the filtered first measurement \vec{c}ₙ₋₁ for the interval 12, i.e. n−1, preceding the interval 12, i.e. n. For this, the third method step 103 is carried out again accordingly for the interval n−1 for the first measurement iₜ₋₁.

Further, a pseudo flow rate measurement value gₙ is then determined by determining, in each case, a mean value from the filtered first measurement \vec{c̅}ₙ₋₁ preceding the filtered first measurement \vec{c}ₙ, the filtered first measurement \vec{c̅}ₙ and the filtered second measurement \vec{f̅}ₙ, adding these mean values, wherein the mean value of the filtered second measurement is weighted by a factor of −2, and dividing the sum by four gₙ=¼(\vec{c̅}ₙ₋₁−2\vec{f̅}ₙ+\vec{c̅}ₙ). The mean values are arithmetic mean values.

In a second alternative of a fourth method step 104b, the controller 4 determines the filtered second measurement \vec{f}ₙ₋₁ for the interval 12, i.e. n−1, preceding the interval 12, i.e. n. For this, the third method step 103 is executed again accordingly for the interval n−1 for the second measurement \vec{d}ₙ₋₁.

Further, a pseudo flow rate measurement value gₙ is then determined by determining, in each case, a mean value from the filtered second measurement \vec{f̅}ₙ₋₁ preceding the filtered second measurement \vec{f}ₙ, the filtered second measurement \vec{f̅}ₙ and the filtered first measurement \vec{c̅}ₙ, adding these mean values, wherein the mean value of the filtered second measurement is weighted by a factor of −2, and dividing the sum by four gₙ=¼ (\vec{f̅}ₙ₋₁−2\vec{c̅}ₙ+\vec{f̅}ₙ). The mean values are arithmetic mean values.

In a fifth method step 105, the controller 4 then determines the flow rate of the medium 10 through the measuring tube 7 using the pseudo flow rate measurement gₙ. In order to get the correct direction of the flow rate, the direction of the magnetic field is taken into account.

In a sixth method step 106, the controller 4 then controls the filling device using the determined flow rate of the medium 10 through the measuring tube 7, so that the container 6 is filled with a predetermined amount of the medium 10. The amount is given to the controller 4.

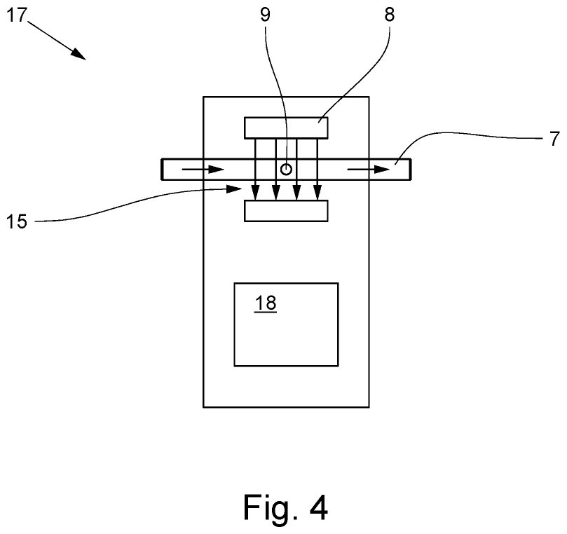

In an abstracted representation, FIG. 4 shows essential features of an embodiment of a further magnetic-inductive flowmeter 17. Again, the flowmeter 17 has a measuring tube 7, a magnetic field generator 8 and two measuring electrodes 9, although only one measuring electrode 9 is also visible in FIG. 4. In addition, the further magnetic-inductive flowmeter 17 has its own controller 18.

The own controller 18 differs from the controller 4 of the filling device 1 in that it is not designed to control the filling device 3. The own controller 18 is designed to carry out a method with the first, second, third, fourth and fifth method steps described above and also carries out this method during operation.

The further magnetic-inductive flowmeter 17 can also be used in the previously described filling device 1, wherein the further magnetic-inductive flowmeter 17 identifies the own controller 18 and the filling device 3 identifies the controller 4. The controllers are then designed to communicate with each other, so that the previously described method can be carried out and is carried out during operation.

1. A method for determining a flow of a medium with a magnetic-inductive flowmeter, wherein the flowmeter includes a measuring tube, a magnetic field generator, two measuring electrodes and a controller, the method comprising:
flowing a medium through the measuring tube;
generating intervals with first sub-intervals and second sub-intervals by the controller;
generating a magnetic field alternating between a first setpoint magnetic field strength in the first sub-intervals and a second setpoint magnetic field strength in the second sub-intervals by the magnetic field generator so that a measuring voltage present between the two measuring electrodes is induced in the medium flowing in the measuring tube;
carrying out a first measurement with a measuring point number of measuring points of the measuring voltage in the first sub-intervals and a second measurement with the measuring point number of measuring points of the measuring voltage in the second sub-intervals by the controller in each of a measuring number of the intervals;
carrying out the following method steps by the controller at least for one of the intervals:
determining an averaged first measurement with a last averaged measurement point from a plurality of the first measurements, and determining an averaged second measurement with a last averaged measurement point from a plurality of the second measurements;
determining a normalized first measurement by subtracting the last averaged measurement point of the averaged first measurement from the averaged first measurement, and determining a normalized second measurement by subtracting the last averaged measurement point of the averaged second measurement from the averaged second measurement; and
determining a filtered first measurement by subtracting the normalized first measurement from the first measurement, and determining a filtered second measurement by subtracting the normalized second measurement from the second measurement; and
determining a flow rate of the medium through the measuring tube by the controller using the filtered first measurements and the filtered second measurements determined at least for the one interval.

2. The method according to claim 1, wherein the filtered first measurement and/or filtered second measurement is determined by the controller also for the interval preceding the interval and the flow rate of the medium is determined additionally using the filtered first and/or second measurement.

3. The method according to claim 2, wherein the filtered first measurement is determined by the controller also for the interval preceding the interval;
wherein a pseudo flow rate measurement value is determined by respectively calculating a mean value from the filtered first measurement preceding the filtered first measurement, the filtered first measurement and the filtered second measurement, these mean values are added;
wherein the mean value of the filtered second measurement is weighted by a factor of minus two, and the sum is divided by four; and
wherein the flow rate of the medium is determined using the pseudo flow rate measurement value.

4. The method according to claim 2, wherein the filtered second measurement is determined by the controller also for the interval preceding the interval;
wherein a pseudo flow rate measurement value is determined by respectively calculating a mean value from the filtered second measurement preceding the filtered second measurement, the filtered second measurement and the filtered first measurement, these mean values are added; and
wherein the mean value of the filtered first measurement is weighted by a factor of minus two, and the sum is divided by four, and the flow rate of the medium is determined using the pseudo flow rate measurement value.

5. The method according to claim 1, wherein an arithmetic or a cumulative moving or exponential moving average is determined for determining the averaged first measurement and the averaged second measurement, respectively.

6. The method according to claim 5, wherein, for determining the averaged first measurement and the averaged second measurement in each case, a curve fitting is carried out with a function to averaged measurement points of the first measurement and to averaged measurement points of the second measurement and wherein the function is an exponential function.

7. The method according to claim 6, wherein the function is used for diagnostic purposes.

8. The method according to claim 1, wherein the execution of the first measurement in the first sub-intervals and of the second measurement in the second sub-intervals is respectively started after a settling time.

9. The method according to claim 1, wherein the first setpoint magnetic field strength in the first sub-intervals and the second setpoint magnetic field strength in the second sub-intervals is constant over time.

10. The method according to claim 1, further comprising using the determined flow rate of the medium through the measuring tube to fill a container with a predetermined amount of the medium.

11. A magnetic-inductive flowmeter, comprising:
a measuring tube,
a magnetic field generator,
two measuring electrodes and
a controller;
wherein the controller is designed to carry out a method including:
generating intervals with first sub-intervals and second sub-intervals;
carrying out a first measurement with a measuring point number of measuring points of the measuring voltage in the first sub-intervals and a second measurement with the measuring point number of measuring points of the measuring voltage in the second sub-intervals in each of a measuring number of the intervals;
carrying out the following method steps at least for one of the intervals:
determining an averaged first measurement with a last averaged measurement point from a plurality of the first measurements, and determining an averaged second measurement with a last averaged measurement point from a plurality of the second measurements;
determining a normalized first measurement by subtracting the last averaged measurement point of the averaged first measurement from the averaged first measurement, and determining a normalized second measurement by subtracting the last averaged measurement point of the averaged second measurement from the averaged second measurement; and
determining a filtered first measurement by subtracting the normalized first measurement from the first measurement, and
determining a filtered second measurement by subtracting the normalized second measurement from the second measurement; and
determining a flow rate of the medium through the measuring tube using the filtered first measurements and the filtered second measurements determined at least for the one interval.

12. A filling system, comprising:
a magnetic-inductive flowmeter;
a filling device; and
a controller;
wherein the flowmeter, has a measuring tube, a magnetic field generator and two measuring electrodes;
wherein the filling device is designed for filling a medium through the measuring tube into containers; and
wherein the controller is designed to carry out a method including:
generating intervals with first sub-intervals and second sub-intervals;
carrying out a first measurement with a measuring point number of measuring points of the measuring voltage in the first sub-intervals and a second measurement with the measuring point number of measuring points of the measuring voltage in the second sub-intervals in each of a measuring number of the intervals;
carrying out the following method steps at least for one of the intervals:
determining an averaged first measurement with a last averaged measurement point from a plurality of the first measurements, and determining an averaged second measurement with a last averaged measurement point from a plurality of the second measurements;
determining a normalized first measurement by subtracting the last averaged measurement point of the averaged first measurement from the averaged first measurement, and determining a normalized second measurement by subtracting the last averaged measurement point of the averaged second measurement from the averaged second measurement; and
determining a filtered first measurement by subtracting the normalized first measurement from the first measurement, and
determining a filtered second measurement by subtracting the normalized second measurement from the second measurement; and
determining a flow rate of the medium through the measuring tube using the filtered first measurements and the filtered second measurements determined at least for the one interval.
